(19) United States
(12) Patent Application Publication
(10) Pub. No.: US 2006/0038901 A1
(43) Pub. Date: Feb. 23, 2006

(54) System and method for recording dynamic range of a photograph's luminance

(75) Inventor: Michael Tapes, Melbourne, FL (US)

Correspondence Address: THORPE NORTH & WESTERN, LLP., 8180 SOUTH 700 EAST, SUITE 200, SANDY, UT, 84070, US

(73) Assignee: PictureFlow, LLC.

(21) Appl. No.: 11/204,832

(22) Filed: Aug. 15, 2005

Related U.S. Application Data
(60) Provisional application No. 60/602,528, filed on Aug. 17, 2004.

(51) Int. Cl. H04N 5/202

(52) U.S. Cl. 348/254

(57) ABSTRACT

A method is disclosed for recording ambient lighting conditions from a reference card using a digital camera to record a spectral response of the reference card to enable a digital photograph to be white balanced. The method can include the operation of providing a substrate to carry a reference surface. A highly polished material can be applied over the substrate to form a reference card having a highly polished surface. The reference card can be photographed with the digital camera to record the ambient lighting conditions.

### CROSS-REFERENCE TO RELATED APPLICATIONS AND CLAIM OF PRIORITY

Priority of U.S. Provisional patent application Ser. No. 60/602,528 filed on Aug. 17, 2004 is claimed.

### BACKGROUND

The present invention relates generally to the field of photography. More particularly, the present invention relates to establishing lighting references in digital photography.

Determining a camera's correct color settings (known as white balance) for different lighting can be challenging. Each light source can produce its own color characteristics. For instance, sunlight during the day can produce a bluish tone, sunlight at night can produce a reddish tone, and incandescent lighting can give off an orange tone. The light source can directly affect the color of a picture taken with a camera. Correcting the color to appear truer to real life is called white balancing. Film manufacturers have long understood the affect which lighting has on pictures. Different types of film are available to compensate for particular light sources, such as outdoor film, indoor film, film for flash photography, and so forth. The use of a correct type of film or film/filter combination for the lighting it was designed for produces purer colors, which can be especially noticeable in lighter colors such as white.

Digital cameras can be affected by the different color characteristics of various light sources in much the same way. Each photoreceptor in a digital camera is designed to record the amplitude of the light. Red, green, and blue filters allow the camera to record digital photographs in color. The coloring, however, can be skewed by the light source. A picture of a wedding gown taken outside can appear to have a bluish tone. The same wedding gown taken inside under incandescent lighting can appear to have an orange tone. To overcome this problem, digital camera manufacturers have developed software to allow white balancing, allowing the color of digital photographs to be adjusted for different lighting techniques.

Digital cameras typically use firmware or hardware built in to the camera which allows a user to adjust the camera settings for different types of lighting. The digital picture can then be manipulated within the camera to compensate for the influence of lighting in the picture's color. However, if the camera is set wrong, say to an outdoor setting when the picture is taken indoors with incandescent lighting, the picture can turn out to appear falsely colored having a color cast. Even worse, once the original data is manipulated and saved by the camera, the original “raw” data is lost and only the picture with the color cast remains. The proper color (eliminating the color cast) often cannot be restored without resulting in damage to the quality of the picture, especially when compression formats such as JPEG are used. Therefore, many professional photographers usually use a different method to achieve white balancing.

Professional photographers often use more expensive digital cameras that enable the photographers to store photographs in a proprietary image format typically referred to as raw data. The raw data is the digital equivalent of a latent film image (the negative before it is developed). It is the actual data recorded by the array of photoreceptors, such as charged-coupled devices (CCDs) or CMOS sensors in a digital camera. The raw data can be downloaded to a computer and manipulated with software. The software can be used to adjust for lighting just as the firmware does in a lower priced camera. The original raw data can be saved so that any digital manipulation performed on an image can be easily reset or changed. However, the lighting conditions must be recorded in order to correctly compensate for lighting conditions after the picture has been taken. Special tools have been developed to record the lighting conditions.

A neutral reflector can be used to show the effects of the ambient lighting. One commonly used neutral reflector is called a gray card. A gray card is designed to have a flattened spectral response over the visible light range. It will equally reflect all colors same luminosity, or brightness for each color in the visible range. Software can then be used to analyze the affects of the lighting source and perform white balancing by canceling out the false-color effects of the light source(s). A picture of a gray card can be taken whenever the lighting changes, allowing correct white balancing to be performed for each lighting situation. Other external measurements (pictures) can also be taken to further enhance a user's ability to compensate for lighting conditions, including measurement of a black and white reference to produce the proper white and black points within the final picture.

A picture of black and white reference cards can be taken in the ambient lighting conditions and used to set upper and lower limits, or dynamic range, of a digital photograph for the lighting conditions that are present. This information can be used by the software to perform similar manipulation of photographs taken in the same lighting conditions as the photos of the reference cards. The data can be of most use when the white source is the brightest white possible and the black source is the blackest possible. This translates to having a white card which reflects nearly 100% of the ambient light and a black reference card which reflects nearly 0% of the ambient light. Various techniques have been used to accomplish this, including use of reference cards comprised of plastic, paper, cloth, and paints. Finding an appropriate black source can be especially difficult.

Gray cards and white reference cards are usually sanded to produce a matte finish, allowing the cards to be photographed at any angle without worrying about glare from the surface of the card. Glare can reduce the value of the data collected from the cards. Producing a matte finish on a black reference card can reduce the black appearance (darkness or blackness) of the card. Glossy cards, however, usually produce a wide angle reflection that creates a glare which can be difficult to avoid when photographing the cards. The result is that most black reference cards reflect between 15% and 25% of the light. The amount of reflection can vary greatly depending upon the light source's angle of incidence between the black reference card and the camera. The greater the amount of reflection, the less black the reference card will appear in a photograph, which can render it useless as a reference. A black reference card which can better approximate black in a photograph is highly desirable.

### SUMMARY

A method is disclosed for recording ambient lighting conditions from a reference card using a digital camera to record a spectral response of the reference card to enable a digital photograph to be white balanced. The method can include the operation of providing a substrate to carry a reference surface. A highly polished material can be applied over the substrate to form a reference card having a highly polished surface. The reference card can be photographed with the digital camera to record the ambient lighting conditions.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is an illustration showing a system for setting a black point with a prior art black reference;

FIG. 2 is an illustration of a three dimensional graph for a Lab color space.

FIG. 3a is an illustration showing a system for setting a black point with a black reference card in accordance with an embodiment of the present invention;

FIG. 3b is an illustration of the angle of light reflected from the black reference card in accordance with an embodiment of the present invention;

FIG. 4 is an illustration showing an embodiment of a black reference card in accordance with an embodiment of the present invention;

FIG. 5 is an illustration showing an embodiment of a set of reference cards in accordance with an embodiment of the present invention; and

FIG. 6 is a flow chart depicting a method for recording ambient light conditions on a black surface using a digital camera in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENTS

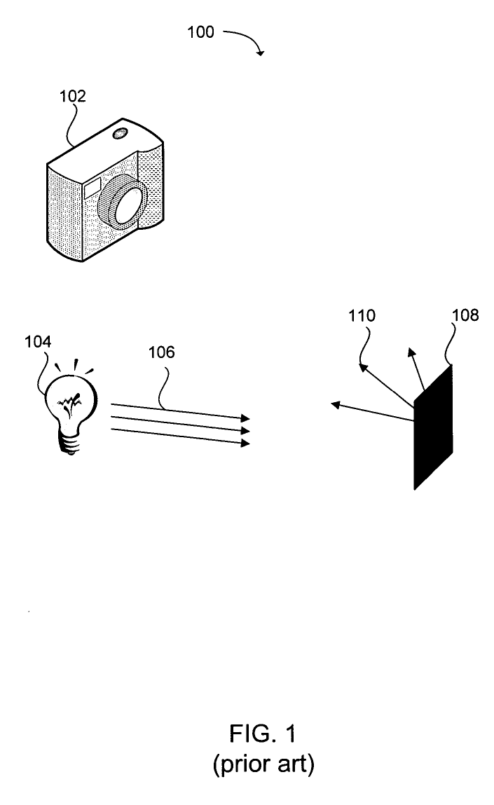

As illustrated in FIG. 1, a prior art system 100 is shown. A digital camera 102 is used to record the lighting conditions from the ambient light source 104 by photographing a black reference card 108. A black reference card is used to record true relative black as it appears in the lighting conditions produced by the ambient light source 104. Software can then be used to manipulate data from the digital photograph and set the black point for the ambient lighting conditions using the black reference card. In order to function correctly, the light reflecting from the surface of the black reference card should be representative of substantially all of the ambient light in the room. Glare from the black reference card should be minimized, as glare represents a light source from a narrow area of the room and can destroy the data sought to be obtained by photographing the black reference card.

For software to be used to correct the color of digital photographs, a mathematical model describing the colors present in the photograph can be applied. A device independent, absolute model used to describe all colors visible to the human eye was developed in 1976 by the International Commission on Illumination (known by the acronym CIE from its French title Commission Internationale de l'Eclairage). The model has been well accepted by professionals, including the International Color Consortium founded by Adobe, Agfa, Apple, Kodak, Microsoft, Silicon Graphics and Sun, and 60 other companies, and is used in most software to compare and define colors in digital pictures.

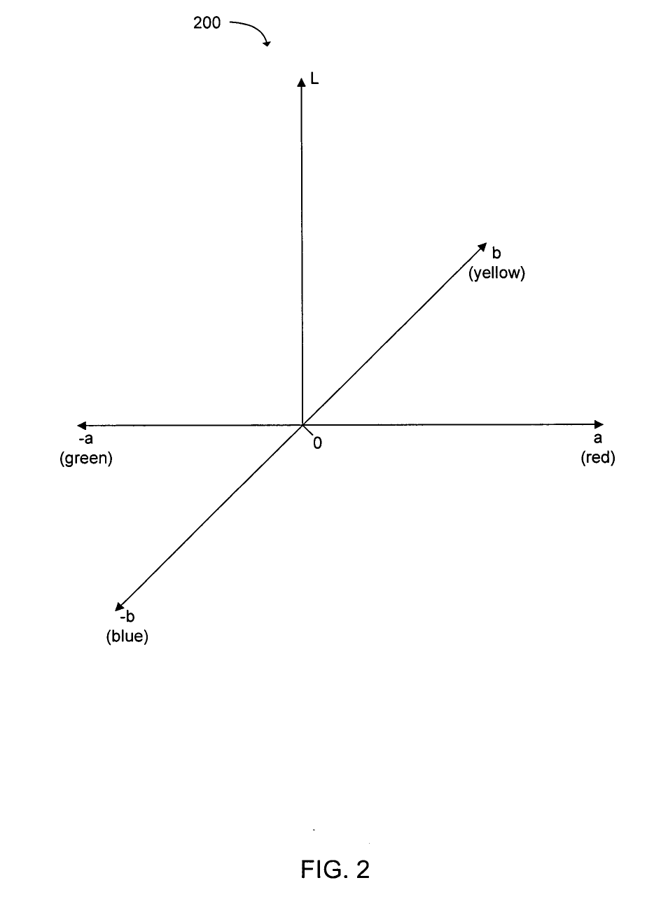

The model is typically referred to as a LAB space model. A color space is defined in three dimensions with three different parameters L, a, and b, as shown in FIG. 2. The first parameter in the model represents the luminance of the light L. The smallest L value yields black, having no luminance. The second parameter, a, represents a position along the a axis between red and green. The a parameter can be either positive or negative, with a larger negative a value trending towards green and a larger positive a value trending towards red. The third parameter, b, represents a position along the b axis between yellow and blue. The b parameter can also be either positive or negative, with a larger negative b value trending towards blue, and a larger positive b value trending towards yellow. A value of zero along the a and b axes represents a location with no color information, just luminance information. By nature, these “colors” (or lack of color) are gray. The gray colors run along the L axis from Black (L=0) to White (L=100). The measurements of L, a, and b values are often abbreviated as Lab values. A spectrophotometer can be calibrated to record absolute Lab values.

Each pixel in a digital photograph can be assigned a specific Lab value, representing the three dimensional color space which defines the pixel's brightness and color. The black reference card can be used as a reference for the software of the lower limit of the luminance, L. When selecting a material to use as a black reference card, the card should idealistically have a Lab value with L, a, and b equal to zero. Realistically, there is always some reflection and the L value is greater than zero.

Theoretically, the “best” black reference card can be determined by selecting or creating a reflecting surface as measured with a calibrated spectrophotometer. The best measurement have Lab values as close to 0 as possible. In practice, however, a black reference card with a lower (better) measured reading, can produce worse results, based on the reference card's reflective characteristics, which can cause a subtle glare to be reflected towards the camera that can diminish the actual photographed value of the black reference card as measured in the resultant photograph. Likewise, a black reference card with a higher (worse) absolute measurement by the spectrophotometer can produce a better result when photographed based on reduced reflective characteristics that measurements by a spectrophotometer can not detect.

Black reference cards are designed to reflect as little light as possible, producing an essentially black color. Creating black reference cards with a matte or dull finish can reduce the apparent darkness of the card in a digital photograph, increasing the L value and reducing the quality of the black reference card used to set the black point for the photograph. Producing cards with a partially glossy black surface, however, can cause wide angled reflections of the ambient light. The partially glossy black surface, while smoother than a matte surface, can still have significant surface imperfections. The broad angle reflection may be caused by the surface imperfections. The surface of the card can be quite rough when compared to the wavelength of the light hitting the surface. Visible light has a wavelength in the range of 400 to 700 nanometers. At that length, a partially glossy surface can relatively have large surface irregularities with respect to the length of the visible light waves hitting the partially glossy surface. Surface irregularities that are substantially larger than the light waves typically reflect incoming light in an essentially randomly fashion. That is, the light is typically reflected off the partially glossy surface in every direction as the light bounces off the relatively rough surface.

Referring again to FIG. 1, light 106 from the ambient light source 104 can be incident on the surface of the prior art black reference card 108 with the reflected light 110 reflecting off of the black reference card 108 over a broad range of angles due to light's reflection from surface imperfections upon the black reference card 108.

The broad range of angles of the reflected light can make it difficult to photograph the black reference card 108 having a partially glossy surface. The relative angle between the black reference card 108 and the camera 102 can be adjusted. However, the broad angle of reflection can make it difficult to adjust the relative angle to a position at which no glare will appear on the surface of the black reference card 108. Also, a low or semi gloss surface can cause a small reflection unable to be easily detected by the human eye, but nonetheless increasing the luminance value L of the black reference card. A black material having a luminance L value of 10 may appear brighter in a picture than a black material having an L value of 20 due to the added reflection. Such difficulties can make the black reference card difficult to use and reduce its appeal to photographers. Therefore, most black reference cards are produced having an essentially matte finish to reduce the amount of glare. The matte finish, however, can increase the luminance value, increasing the amount of reflection and thus reducing the black appearance of the card. Most black reference cards currently for sale on the market have an L value in the range of 20 to 25 when measured using a spectrophotometer.

As previously discussed, the black reference card is used to define a pure black as it exists under the ambient lighting conditions in which photographs will be taken. The black reference card should theoretically reflect 0% of the ambient light, having Lab values of 0, 0, and 0. A black material having these attributes, which can also be portable and durable, is optimally desired. Many materials exist having substantially low Lab values. In practice, however, reflections can cause photographs to record much higher Lab values. Therefore, most photographers settle for a black reference card with a matte finish to minimize hi-glare reflections. While the matte finish may reduce the high glare of a reflective black reference card, it does not allow for the lowest absolute Lab value. A photographer can obtain more realistic Lab values using the matte finish since it reduces even small amounts of reflection and glare. With reduced glare, the matte finish can increase the quality of the black reference card measurements even though it may not have as dark a finish as a black reference card having a glossier surface. Therefore, photographers have generally selected black reference cards having a matte finish as optimal.

The inventor has discovered, however, that contrary to previous practice in the industry, creating black reference cards having a substantially increased amount of reflection can lead to superior results over black reference cards having a reduced reflection, such as a matte finish. The inventor found that a black material having substantially idealistic Lab values can be polished or coated to have a highly polished surface. The highly polished surface can be useful in reflecting light away from the camera and in the detection of glare producing circumstances.

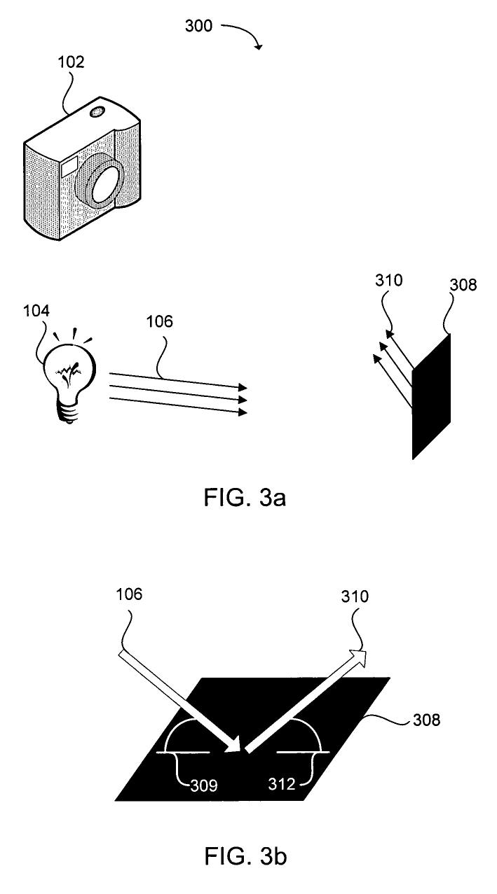

An example implementation of the present invention is illustrated in FIGS. 3a and 3b. A system 300 is shown comprising the digital camera 102 configured to record the lighting conditions of the ambient light 104 as they appear on the black reference card 308. Creating a significantly smoother surface, it was discovered, could allow the black reference card 308 to appear darker, while enabling it to have a much narrower angle of reflection. A highly polished smooth surface can be essentially smooth compared to the wavelength of the light 106 incident on the surface of the black reference card 308. The smooth surface can significantly reduce the amount of scattered light due to a rough surface.

As shown in FIG. 3b, the light 106 incident on the surface of the black reference card 308 can be reflected at an angle 312 essentially equal to the angle of incidence 310 at which the light 106 hits the black reference card 308. Thus, a photographer can easily position the black reference card 308 so that the incident light 106 from the ambient light source 104 is reflected 310 away from the camera 102, as shown in FIG. 3a.

The highly polished black surface of the black reference card 308 can enable the black reference card 308 to appear to be significantly darker to the camera 102. When the black reference card 308 is positioned such that the reflected light 310 is directed away from the camera 102, the amount of light reflected from the surface of the black reference card 308 to the camera 102 can be notably reduced. The highly polished surface can enable a photographer to more easily notice light reflected off the black reference card 308, allowing the photographer to adjust the angle of the black reference card 308 with respect to the camera before recording the ambient lighting conditions.

In one test, a prior art black reference card 108 (FIG. 1) had a relative L value of greater than 10, due to the greater amount of reflection of the ambient light source by the card. A black reference card 308 having a highly polished surface had a relative L value of 3 in the same ambient lighting conditions as the prior art black reference card 108.

The amount of ambient light reflected off the surface of the black reference card 308 toward the camera 102 can be reduced to less than a relative L value of 10%. In many cases the amount of light reflected off the surface of the black reference card can be less than 6%. This is a substantial improvement over the 15% to 25% of light that is typically reflected off of a black card having a matte surface. In comparison, other black reference cards, such as but not limited to matte or semi-gloss, have L values in the range of 16 and higher (worse). The reduced L value of the black reference card 308 is a substantial improvement over the previous art. The reduced reflection can improve the measurements of what a true black will look like under the ambient lighting conditions in which photographs are to be taken. Software can then be used to better correct photographs taken in substantially similar ambient lighting conditions using the information obtained by photographing the black reference card 308 having a highly polished surface. The improved L value of the highly polished surface can enable the software to make better corrections compared to prior art reference cards.

A black reference card having a highly polished surface can comprise a black material having a surface which is relatively smooth compared to the wavelength of light in the visible spectrum. Alternatively, it can also be possible to laminate a clear film having a high gloss finish over the black surface. The high gloss surface should be relatively smooth compared to the wavelength of electromagnetic energy such that a significant portion of the electromagnetic energy incident on the surface of the high gloss surface will be reflected at the same angle at which the light is incident on the card. In one embodiment the electromagnetic energy can be comprised of light in the visible light spectrum. In another embodiment the electromagnetic energy can be comprised of electromagnetic waves in the infrared spectrum. In a further embodiment the electromagnetic energy can be comprised of electromagnetic waves in the ultraviolet spectrum.

In one embodiment, a substrate having a black finish can be laminated to a high gloss Mylar® or polyester plastic having a thickness of 2 mils. The high gloss laminate can have surface imperfections having an average height of less than 1500 nanometers. In another embodiment, surface imperfections on a highly glossy surface such as a high gloss laminate can have an average height of less than 700 nanometers. In a further embodiment, surface imperfections on a highly glossy surface such as a high gloss laminate can have an average height of less than 400 nanometers. The laminate can provide a durable product that is abrasion and smear resistant, enabling the highly polished black reference card 308 to be used in a variety of outdoor and extreme conditions with minimal wear.

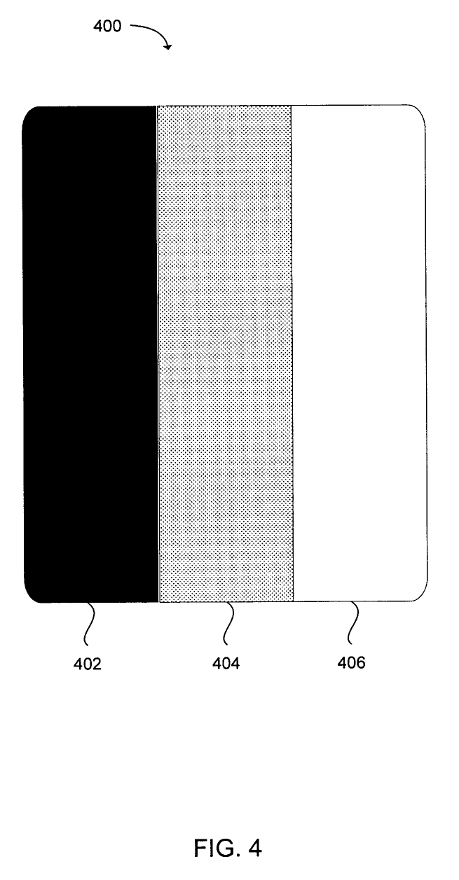

In another embodiment, the black reference card having a highly polished surface can be integrated on a card having other types of surfaces. For example, a tricolor card 400 may comprise three sections: a first section having a highly polished black finish 402; a second section having a gray matte finish 404; and a third section having a white matte finish 406, as shown in FIG. 4. The card can be adjusted so that the angle of reflection from the ambient light on the highly polished black finish 402 does not direct the light towards the digital camera, as shown in FIGS. 3a and 3b.

The tricolor card 400 can be a relatively large and rigid card having a major dimension of more than 8 inches. Another embodiment can include placing the three surfaces on a relatively small strip having a major dimension of less than 4 inches. Alternatively, the gray, highly polished black, and white surfaces can be arranged on three separate reference cards.

In a further embodiment, the reference cards can include a plurality of gray cards. For example, a 3 card reference card set 500 can include a white card reference 506, a light gray card reference 504, and a dark gray card reference 508. A black reference 502 may be located on one of the reference cards. In one embodiment, the black reference may be a sticker applied to the white reference card, though it may be applied to any of the reference cards. A fastener 510 may be used to couple the reference cards together for ease of use. The fastener may be a rivet, tie, bolt and nut, or any other viable device used for fastening the reference cards together. The fastener can enable the various reference cards to be maintained in a substantially similar plane so that all of the reference cards reflect a similar amount of light from the same light sources. The reference cards may be supported by a stand configured to support the reference cards to enable them to be photographed at predetermined angles.

As previously disclosed, the gray reference cards 504, 508 are designed to be spectrally neutral, having Lab space a and b values that are theoretically as close as possible to zero. In one embodiment, the a and b absolute values for the gray reference cards are less than 1. The black reference 502 can be configured to have a highly glossy surface that is approximately smooth compared to the wavelength of the light, as previously discussed.

While the gray reference cards are typically produced with a matte surface, to limit the amount of reflection from a particular light source, the matte surface can still produce a substantial reflection, especially from a bright light source. The reflection can interfere with the ability to record an accurate reference value of the lighting at a particular location. In one embodiment, a photographer can reduce the amount of glare on the matte surfaces of the gray reference cards 504, 508 by using the highly glossy surface of the black reference to determine whether there is significant reflection. The glossy surface can enable the photographer to determine if the reference cards have a substantial reflection. Since the fastener 510 maintains the reference card set 500 in substantially the same plane, a reflection from the highly polished black reference 502 will show that there is likely a similar (though less visible) reflection off of the matte surfaces of the gray reference cards. The angle between a camera and the reference card set can be adjusted until the amount of reflection from the black reference has been reduced, which will also reduce the reflection from the matte surfaces.

In another embodiment, a highly polished surface that is approximately smooth compared to the wavelength of the light can be applied to at least one of the gray reference cards 504 and 508. The highly polished surface may be a substantially transparent plastic film. The highly polished surface can enable a photographer to directly view any glare that is visibly present on the gray reference cards. The angle between the reference card set 500 and a camera can then be adjusted until the amount of reflection from the reference card set has been reduced as much as possible.

Adding a highly polished surface to the gray reference card(s) 504 and 508 can also add additional improvements beyond enabling the photographer to adjust the angle of reflection. When the gray reference card(s) have a matte surface, the reflected light 110 is diffused and reflected over a wide angle, as shown in FIG. 1. When a highly polished surface is added to the gray reference card(s), then the light 106 can be reflected 310 at an angle 312 incident to the light source, as shown in FIG. 3, allowing the photographer to adjust the reference card set 500 until substantially all visible glare is directed away from the camera. Eliminating or reducing glare can improve the accuracy of the Lab values for both the black reference and the gray reference card(s). Improving the accuracy of the Lab values can allow pictures to be adjusted to more accurately display the lighting in a photograph.

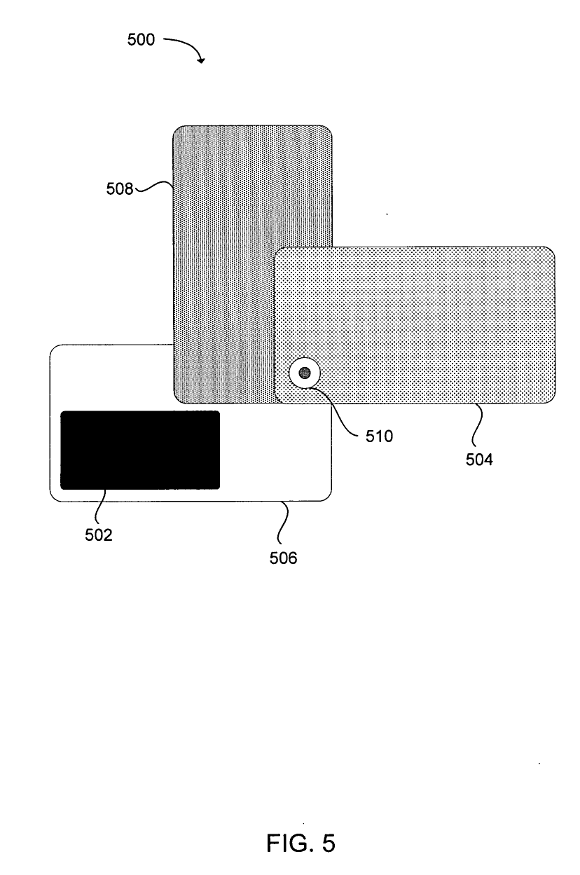

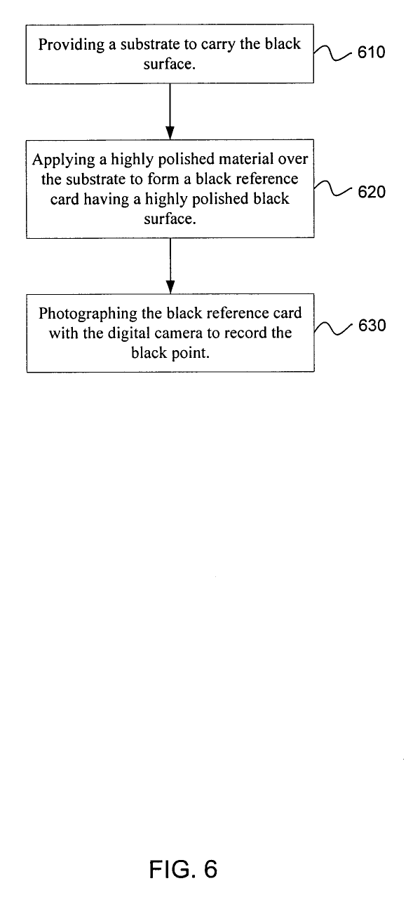

Another aspect of the invention provides a method for recording ambient light conditions on a black surface using a digital camera to record a black point to set a lower limit of a dynamic range of a photograph's luminance, as depicted in the flow chart of FIG. 5. The method can include the operation of providing a substrate to carry the black surface, as shown in block 610. The substrate can be comprised of paper, plastic, metal, cloth, plastic, or a combination of these materials. The substrate can preferably be comprised of a substantially rigid material in order to eliminate bending of the substrate. Bending can cause the incident light to reflect off at a plurality of angles. The substantially rigid substrate can allow the incident light to be reflected at the angle of incidence. The substrate can have a black surface, or alternatively a black surface can be applied to the substrate. The black surface can be comprised of paper, plastic, cloth, paint, ink, dye, and pigment or a combination of the materials. The black surface can be any material which can be substantially black and can reflect light substantially equally over the visible spectrum to have a substantially flat response to incident light over the visible spectrum. In another embodiment, the black surface can be selected to have a substantially flat response to incident light over the infrared and/or ultraviolet light spectrum.

A further operation involves applying a highly polished material over the substrate to form a black reference card having a highly polished black surface, as shown in block 620. As previously discussed, the highly polished material can be any material having a surface that is approximately smooth compared to the wavelength of visible light. A substantial portion of light hitting the approximately smooth surface at an incident angle can be reflected from the surface at a reflected angle that is equal to the incident angle. The light is able to be reflected at the angle of incidence because the surface is substantially smooth compared to the wavelength of light.

The black reference card can be oriented such that incident light reflected from the black reference card is directed away from the digital camera. Because the surface of the highly polished black surface can be relatively smooth compared to the wavelength of visible light, the light incident on the card will be reflected at an angle that is substantially similar to the angle of the incident light on the card. This can allow a highly polished black surface to easily be oriented such that the incident light is reflected away from the digital camera.

A further operation involves photographing the black reference card with the digital camera to record the black point, as shown in block 630. The highly polished black surface can allow considerably less light to be reflected towards the camera. Instead of being reflected at a variety of angles, a significant amount of the incident light can be reflected at the incident angle, allowing a photographer to easily orient the card to direct the light away from the camera. The highly polished black reference card can provide a much improved standard for black in digital photography over the prior art.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method for recording ambient light conditions on a black surface using a digital camera to record a black point to set a lower limit of a dynamic range of a photograph's luminance, comprising:
providing a substrate to carry the black surface;
applying a highly polished material over the substrate to form a black reference card having a highly polished black surface;
photographing the black reference card with the digital camera to record the black point.

2. A method as in claim 1, wherein providing a substrate further comprises providing a substrate to carry the black surface, wherein the black surface is selected to have minimal Lab values as recorded by a calibrated spectrophotometer.

3. A method as in claim 1, further comprising orienting the black reference card such that incident light reflecting off of the black reference card is directed away from the digital camera before photographing the black reference card.

4. A method as in claim 1, further comprising applying a highly polished material over the substrate, wherein the highly polished material has a surface that is approximately smooth compared to the wavelength of visible light such that a substantial portion of light hitting the surface at an incident angle will be reflected from the surface at a reflected angle that is equal to the incident angle.

5. A method as in claim 4, further comprising applying a highly polished material over the substrate, wherein the highly polished material has surface imperfections having an average height of less than 1500 nanometers.

6. A method as in claim 4, further comprising applying a highly polished material over the substrate, wherein the highly polished material has surface imperfections having an average height of less than 700 nanometers.

7. A method as in claim 4, further comprising applying a highly polished material over the substrate, wherein the highly polished material has surface imperfections having an average height of less than 400 nanometers.

8. A method as in claim 1, further comprising forming the substrate using one or more materials selected from the group consisting of paper, plastic, and metal.

9. A method as in claim 8, further comprising forming black surface on the substrate using one or more materials selected from the group consisting of paper, plastic, cloth, paint, ink, dye, and pigment.

10. A method as in claim 9, further comprising selecting the one or more materials for the black surface such that the black surface has a substantially flattened spectral response to electromagnetic energy that is incident on the black surface, wherein the electromagnetic energy is in one or more of the infrared, visible light, and ultraviolet spectrums.

11. A method as in claim 1, further comprising forming the highly polished material using one or more materials selected from the group consisting of Mylar, highly polished Mylar, and polyester.

12. A method as in claim 12, further comprising selecting the highly polished material such that the material is substantially transparent to electromagnetic energy in at least one of the infrared, visible, and ultraviolet spectrums.

13. A method as in claim 1, further comprising using the recorded black point in software configured to alter digital photographs based on the recorded black point.

14. A system for recording ambient light conditions on a black surface using a digital camera to record a black point to set a lower limit of a dynamic range of a photograph's luminance, comprising:
a substrate configured to carry the black surface; and
a highly polished material coupled to the substrate to form a black reference card having a highly polished black surface.
a digital camera configured to photograph the black reference card to record the black point.

15. A system as in claim 14, wherein the black reference card is configured to have a minimal Lab value as recorded by a calibrated spectrophotometer.

16. A system as in claim 14, wherein the black reference card has an L value of less than 4 as recorded by a calibrated spectrophotometer.

17. A system as in claim 14, wherein the black reference card reflects less than 10% of the ambient light.

18. A system as in claim 14, wherein the black reference card reflects less than 6% of the ambient light.

19. A system as in claim 14, wherein the highly polished black surface is located on a card having two or more colors.

20. A system as in claim 19, wherein the card comprises three colors consisting of a white surface, a gray surface, and a highly polished black surface.

21. A system for recording ambient light conditions on a black surface using a digital camera to record a black point to set a lower limit of a dynamic range of a photograph's luminance, comprising:
a means for providing a substrate to carry the black surface;
a means for applying a highly polished material over the substrate to form a black reference card having a highly polished black surface;
a means for photographing the black reference card with the digital camera to record the black point.
a highly polished black reference card configured to provide a black reference in a photograph, the card having a black surface configured to reflect light incident on the card, wherein the light is incident on the card at an angle of incidence, and the light is reflected at an angle substantially similar to the angle of incidence.

22. A method for recording ambient lighting conditions on a reference card using a digital camera to record a spectral response of the reference card to enable a digital photograph to be white balanced, comprising:
providing a substrate to carry a reference surface;
applying a highly polished material over the substrate to form a reference card having a highly polished surface; and
photographing the highly polished reference card with the digital camera to record the ambient lighting conditions.

23. A method as in claim 22, wherein providing a substrate further comprises providing a substrate to carry a reference surface, wherein the reference surface has a reference color selected from the group consisting of white, light gray, dark gray, and black.

24. A method as in claim 22, wherein applying a highly polished material further comprises applying a highly polished material selected from the group consisting of Mylar, highly polished Mylar, and polyester.

25. A method as in claim 22, wherein photographing the highly polished reference card further comprises adjusting an angle between the reference card and the digital camera to reduce an amount of light reflected from the reference card to the digital camera.

26. A method as in claim 22, further comprising attaching at least two reference cards in such a way that the reference cards lie in substantially the same plane.
